(19) United States
(12) Patent Application Publication
(10) Pub. No.: US 2024/0289117 A1
(43) Pub. Date: Aug. 29, 2024

(54) SMART TERMINAL MANAGEMENT SYSTEM FOR UPDATING TERMINAL SOFTWARE

(71) Applicant: VeriFone, Inc., Wilmington, DE (US)

(72) Inventors: Nicholas Kenneth John Tristram, Hillingdon (GB); Joachim Vance, Oceano, CA (US)

(73) Assignee: VeriFone, Inc., Wilmington, DE (US)

(21) Appl. No.: 18/573,687

(22) PCT Filed: Jun. 22, 2022
(86) PCT No.: PCT/US2022/073083

§ 371 Date: Dec. 22, 2023

Related U.S. Application Data
(60) Provisional application No. 63/213,404, filed on Jun. 22, 2021.

(51) Int. Cl. G06F 8/65; G06Q 20/32

(52) U.S. Cl. CPC G06F 8/65; G06Q 20/3276; G06Q 20/3278

(57) ABSTRACT

A system for facilitating a software update is provided. The system includes a payment terminal, a mobile device, and a remote server. The payment terminal displays, via a screen, a QR code. The QR code includes terminal data corresponding to the payment terminal. The mobile device captures the QR code displayed on the payment terminal, generates an update initiation command based at least in part on the terminal data of the QR code, and transmits the update initiation command. The remote server receives the update initiation command transmitted by the mobile device and transmits a software package to the mobile device in response to receiving the update initiation command. The mobile device then transmits, via a wired or wireless connection, the software package to the payment terminal. The payment terminal then installs the software package.

### CROSS-REFERENCE TO RELATED APPLICATIONS

This application claims priority to U.S. Provisional Patent Application Ser. No. 63/213,404, filed on Jun. 22, 2021, which application is hereby incorporated by reference in its entirety.

### FIELD OF THE DISCLOSURE

The present disclosure is directed generally to systems and methods for providing software updates to payment terminals.

### BACKGROUND

Many payment terminals operate in environments which do not allow them direct network access. Further, these payment terminals may not be Internet Protocol (IP) connected. An example of such a payment terminal is a personal identification number (PIN) pad connected to an electronic cash register (ECR). Other environments work with very low bandwidth IP connections or expensive IP connections for volume data. As such, lack of connectivity, low bandwidth, and expensive data plans can prevent the transfer of large files required to update the software of a payment terminal. Accordingly, there is a need for systems and methods for providing software updates to payment terminals in such environments.

### SUMMARY OF THE DISCLOSURE

The present disclosure is directed to systems and methods for providing software updates to a payment terminal. These systems and methods use a mobile device (such as a smartphone) to “push” a software update from a remote server to a payment terminal when the payment terminal is unable to directly retrieve the software update from the remote server due to hardware and/or network limitations.

When a software update is required for a payment terminal, a merchant operator provides terminal data (such as data regarding the hardware and/or software of the payment terminal) to a mobile device. In one example, this terminal data is coded into a quick response (QR) code displayed by a screen on the payment terminal. The mobile device then captures the QR code using a camera and extracts the terminal data from the QR code. In other examples, the merchant operator manually enters the required terminal data into the mobile device via touchscreen or keypad. The mobile device then transmits an update initiation command based on the terminal data to a remote server, such as an app store. The remote server then provides the mobile device with a software package corresponding to the update initiation command. The mobile device then transmits the software package to the payment terminal via wired (On-the-Go (OTG) cable) or wireless (Wi-Fi, Bluetooth, Near Field Communication (NFC)) means. The payment terminal then receives and installs the software package, successfully updating its software despite the previously described hardware and/or network limitations. In some examples, the mobile device requests remote server log-in credentials from the merchant operator. The log-in credentials are then forwarded to the remote server for verification prior to transmitting the software package to the mobile device.

In a further example, the remote server transmits a software update preparation command prior to transmitting the software update. The software update preparation command may implement a download management plan or provide a payload with files (such as media files) used by the software package in updating the terminal software. This software update preparation command may be signed and/or encrypted by the remote server using one or more symmetric keys. The software update preparation command is then transmitted to the mobile device, which forwards the software update preparation command to the payment terminal. The payment terminal stores symmetric keys corresponding to the keys used by the remote server to authenticate and/or decrypt the software update preparation command. This encryption and/or authentication improves security and data integrity by preventing intermediate devices (such as the mobile device) from modifying and/or reading the software update preparation command. The sharing of the symmetric key pairs may be facilitated by asymmetric key pairs and/or certificates provided to the payment terminal and remote server during manufacturing.

Generally, in one aspect, a system for facilitating a software update is provided. The system includes a payment terminal. The payment terminal is configured to display, via a screen, a QR code. The QR code includes terminal data. The terminal data corresponds to the payment terminal.

The system further includes a mobile device. The mobile device is configured to capture the QR code displayed on the payment terminal. The mobile device is further configured to generate an update initiation command. The update initiation command is generated based at least in part on the terminal data of the QR code. The mobile device is further configured to transmit the update initiation command.

The system further includes a remote server. The remote server is configured to receive the update initiation command. The update initiation command is transmitted by the mobile device. The remote server is further configured to transmit a software package to the mobile device in response to receiving the update initiation command. The remote server may be an app store.

The mobile device is further configured to transmit, via a wired or wireless connection, the software package to the payment terminal. According to an example, the wired or wireless connection utilizes Wi-Fi, Bluetooth, or NFC. In another example, the wired or wireless connection utilizes an OTG cable. The payment terminal is further configured to install the software package.

According to an example, the payment terminal may be further configured to receive, via the wired or wireless connection, a software update preparation command. The software update preparation command is encrypted and/or signed by a first key. The payment terminal may be further configured to decrypt and/or authenticate, via a second key corresponding to the first key, the software update preparation command prior to receiving the software package. The second key may be stored in a memory of the payment terminal. The software update preparation command may include a payload corresponding to the software package.

Generally, in another aspect, a mobile device is provided. The mobile device includes a processor. The processor is configured to transmit, via a communication channel, an update initiation command to a remote server. The update initiation command corresponds to terminal data of a payment terminal.

The processor is further configured to receive, via the communication channel, a software package transmitted by the remote server. The software package corresponds to the update initiation command.

The processor is further configured to transmit, via a wired or wireless connection, the software package to the payment terminal. The wired or wireless connection is different than the communication channel. According to an example, the wired or wireless connection utilizes Wi-Fi, Bluetooth, or NFC. According to another example, the wired or wireless connection utilizes an OTG cable.

According to an example, the processor is further configured to capture a QR code displayed on the payment terminal. The QR code includes the terminal data of the payment terminal. The processor is further configured to generate the update initiation command based at least in part on the terminal data of the QR code.

According to an example, the processor is further configured to transmit, prior to transmission of the software package, a software update preparation command. The software update preparation command is encrypted and/or signed.

Generally, in another aspect, a method for updating software of a payment terminal is provided. The method includes transmitting, via a mobile device over a communication channel, an update initiation command to a remote server. The update initiation command corresponds to terminal data of the payment terminal. The method further includes receiving, via the mobile device over the communication channel, a software package transmitted by the remote server in response to receiving the update initiation command. The method further includes transmitting, via the mobile device over a wired or wireless connection that is different than the communication channel, the software package to the payment terminal. The payment terminal is configured to install the software package upon receipt. According to an example, the software package may be received by the mobile device via Wi-Fi or mobile data. According to a further example, the software package may be transmitted by the mobile device to the payment terminal via Wi-Fi, Bluetooth, NFC, or an OTG cable.

According to an example, the method may further include scanning, via the mobile device, a QR code displayed by the payment terminal. The QR code includes the terminal data corresponding to the payment terminal. The method may further include generating, via the mobile device, the update initiation command based at least in part on the terminal data of the QR code.

According to an example, the method may further include transmitting, via the mobile device, log-in credentials to the remote server. The remote server is configured to verify the log-in credentials prior to transmitting the software package to the mobile device

According to an example, the method may further include transmitting, via the mobile device, a software update preparation command to the payment terminal. The software update preparation command may be encrypted and/or signed.

In various implementations, a processor or controller may be associated with one or more storage media (generically referred to herein as “memory,” e.g., volatile and non-volatile computer memory such as RAM, PROM, EPROM, EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

FIG. 1 schematically illustrates an example system in which a payment terminal lacks direct access to an external network.

FIG. 2 schematically illustrates an example system in which a payment terminal is connected to a local network, but external access to a public network is restricted by a firewall or other location restrictions.

FIG. 3 schematically illustrates an example system in which a payment terminal is connected to an ECR via a low-tech connection.

FIG. 4 schematically illustrates an example system in which a payment terminal is connected to network end points via another type of low-tech connection.

FIG. 5 schematically illustrates an example system in which the payment terminal is connected to a mobile data network but is restricted by a low volume data plan.

FIG. 6 schematically illustrates an example mobile smart terminal management system (TMS) for providing a software update to a payment terminal, according to aspects of the present disclosure.

FIG. 7 is a flow diagram illustrating a payment device and a remote server exchanging authentication and encryption keys, according to aspects of the present disclosure.

FIG. 8 is a flow diagram illustrating a remote server providing an authenticated and/or encrypted software update preparation command and software update package to a payment terminal, according to aspects of the present disclosure.

FIG. 9 is a schematic illustration of a payment device, according to aspects of the present disclosure.

FIG. 10 is a flow chart of a method for updating software of a payment terminal, according to aspects of the present disclosure.

### DETAILED DESCRIPTION

The present disclosure is directed to systems and methods for providing software updates to a payment terminal. These systems and methods use a mobile device (such as a smartphone) to “push” a software update from a remote server to a payment terminal when the payment terminal is unable to directly retrieve the software update from the remote server due to hardware and/or network limitations.

FIG. 1 illustrates a system including a payment terminal 100, a universal serial bus (USB) cable 102, an electronic cash register (ECR) 200, a cloud computing network C, and a remote server 300. The payment terminal 100 may be any customer-facing device capable of facilitating transactions, in particular transactions involving payment cards (such as credit or debit cards). In the example of FIG. 1, the payment terminal 100 may be configured as a personal identification number (PIN) entry device (PED). The ECR 200, also known as a point-of-sale (POS) device, may be any merchant-facing device capable of facilitating transactions. The ECR 200 is wirelessly connected to the remote server 300 via the cloud computing network C. The remote server 300 may function as a payment host headquarters for processing transactions and payment information received by the payment terminal 100 and/or the ECR 200. In the example of FIG. 1, the payment terminal 100 lacks direct access to the cloud computing network C and the remote server 300. Rather, the payment terminal 100 is connected to the ECR 200 via the USB cable 102. Accordingly, the payment terminal 100 is not on an Internet Protocol (IP) network, meaning that the payment terminal 100 is unable to provide a heartbeat signal or otherwise be accessed by the payment host headquarters.

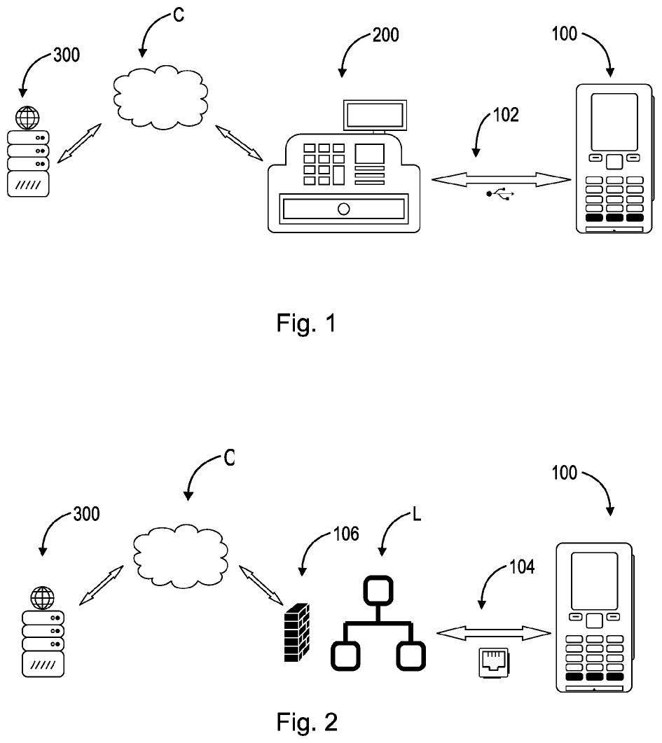

FIG. 2 illustrates an example in which the payment terminal 100 is connected to a local area network (LAN) L via an ethernet cable 104. However, external access to a cloud computing network C and a remote server 300 is restricted by a firewall 106 or other location restrictions. In some cases, this can be overcome by whitelisting the payment host headquarters domain and/or IP, but this whitelisting requires coordination with the client to ensure that whitelisting has occurred at all locations. This also restricts the payment host, should the payment host decide to change or support multiple IPs or domains.

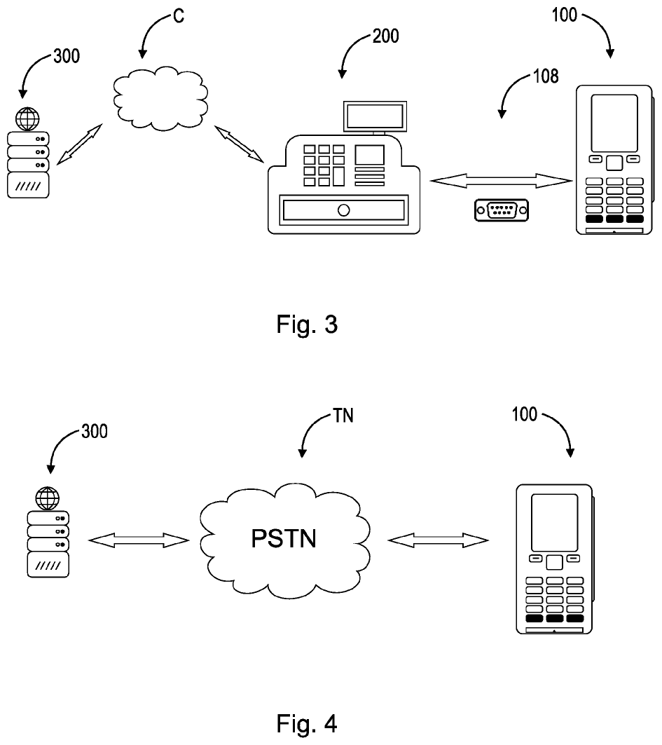

FIG. 3 illustrates an example in which a payment terminal 100 is connected to an ECR 200 via a low-tech connection. In this example, the payment terminal is connected to the ECR 200 via a low-tech RS-232 serial cable 108. The bandwidth on the RS-232 serial cable 108 is too low to run an effective IP over serial connection. Accordingly, the limited bandwidth results in considerable time (such as hours) being required to transfer large payloads, such as a software package. While payment providers have encouraged merchants to move to USB-enabled systems, in many cases, the POS systems are old and do not have available universal asynchronous receiver-transmitter (UART) or USB ports. Also, as the cost of re-cabling many legacy POS systems is considerable, many merchants do not want to overhaul their current configuration and simply prefer a replacement PED.

FIG. 4 illustrates an example in which a payment terminal 100 is connected to network end points (such as a remote server 300 embodied as a payment host) via another type of low-tech connection. In this example, the payment terminal 100 is connected to the end points via a public switched telephone network (PSTN) TN. Many small merchants do not want or cannot install a broadband connection at their business location. This means that transactions must be processed via dial-up connections to the payment host. However, if the payment host headquarters only supports IP connectivity, payloads would take a long time to download to the payment terminal 100.

In some situations, it may be feasible for the payment terminal 100 to dial into a serial line Internet protocol (SLIP) or point-to-point protocol (PPP) service to access an IP network. However, dialing-in and connecting can take considerable time, and, in reality, the download speed may be as low as 19.2 k depending on the modem and quality of the PSTN network. This means downloading a full software update for Android terminals could take days, which is too long to be usable in most situations.

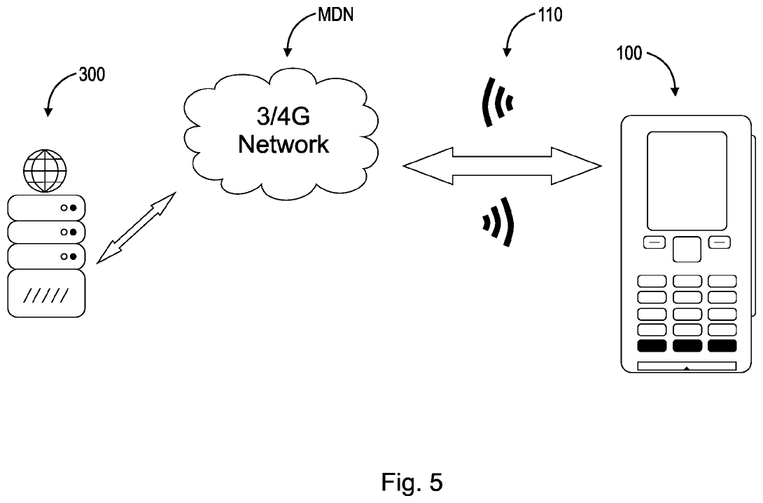

FIG. 5 illustrates an example in which a payment terminal 100 is connected to a mobile data network MDN via a bidirectional mobile data connection 110 but is restricted by a low volume data plan. In FIG. 5, the payment terminal 100 establishes the mobile data connection 110 via 2G, 3G, or 4G, but has a low volume and/or expensive data plan. In this case, upgrading the software stack can take considerable time, such as between 20-40 min (depending on bandwidth). If the data plan only covers up to 5 MB per month, this plan may only be sufficient for transactional data during the month. This transactional data may include data for transactions and settlement, as well as heartbeat data. In this case, re-downloading an update that initially failed for some reason (such as poor connectivity) can result in exceeding the data plan and charging the merchant a much higher cost.

Generally, a payment terminal 100 requires IP connectivity to a remote server 100 operated by payment host headquarters to allow the payment host to, at least, (1) upgrade the software stack of the payment terminal 100, (2) update application parameters and configuration of the payment terminal 100, and (3) monitor the health & state of the payment terminal 100. Restrictive bandwidth and the inability to perform IP connected operations make it extremely difficult to upgrade the software stack for at least the following reasons: (1) the payment host headquarters requires an IP connection to manage the device; (2) ECR 200 and POS integrated solutions may prohibit external connections from attached devices; (3) ECR 200 and POS integrated solutions may only have USB 102 or RS-232 108 connections; (4) USB 102 and RS-232 108 connections can take a long time to download over limited bandwidth connections; and (5) some mobile subscriber identity module (SIM) data plans are very frugal or expensive, and hence will not cover downloading regular software upgrades. The following solution aims to resolve the problem of upgrading and maintaining terminal software when (1) the payment terminal 100 does not have access to an IP network, or (2) the communications bandwidth is so poor that direct over the air (OTA) updating is not possible.

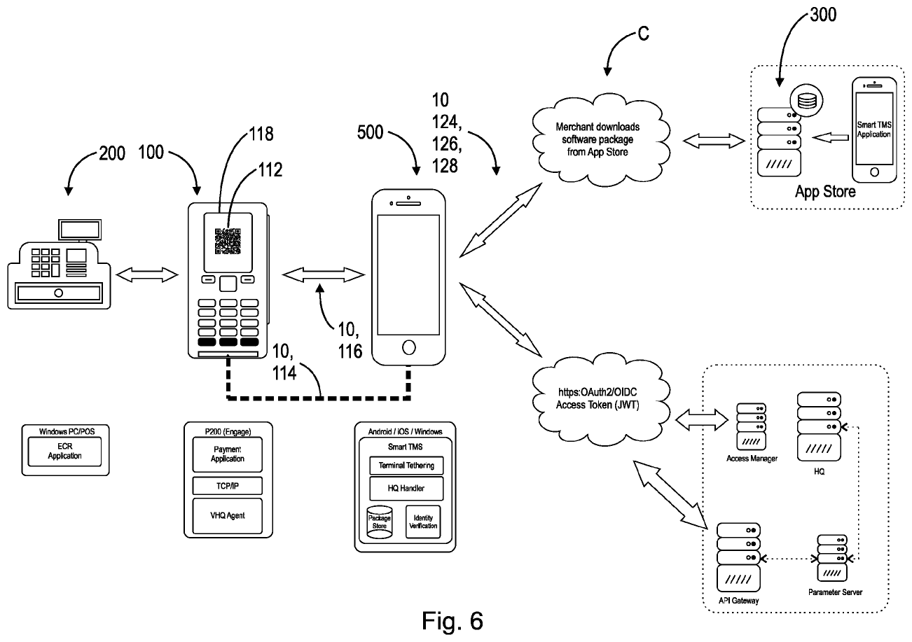

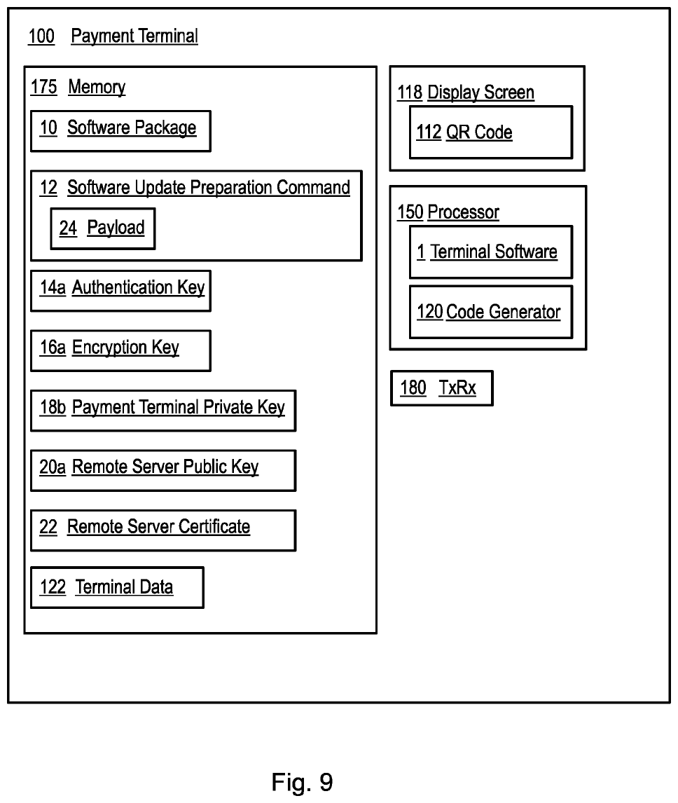

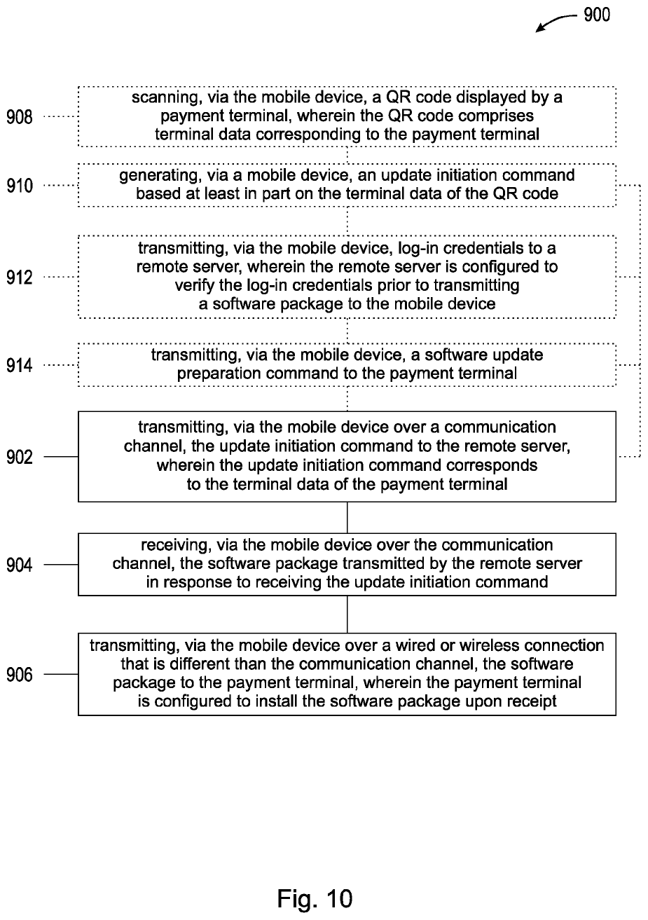

FIG. 6 illustrates a mobile smart terminal management system (TMS) solution to the aforementioned problems. The mobile smart TMS architecture aims to allow a merchant to use a mobile device 500 (such as a smartphone) to download the software packages 10 from remote server 300, such as an app store, and then transfer the software package 10 to the payment terminal 100. The merchant must provide terminal data 122 (see FIG. 9) to the mobile device 500. The terminal data 122 could include any relevant information regarding the payment terminal 100, including make, model, serial number, age, operating status, current software and/or firmware versions, etc. In one example, the terminal data 122 may be manually entered into a user interface of the mobile device 500. In another example, the payment terminal 100 may display a quick response (QR) code 112 embedded with the terminal data 122.

The mobile device 500 may then capture the QR code 112 using a camera and extract the terminal data 122 from the QR code 112 using QR code processing software. The extracted terminal data 122 may be stored in a memory of the mobile device 500 so the merchant can retrieve the software package 10 at a later date, time, and/or location. The mobile device 500 then generates an update initiation command 124 based on the terminal data 122. The mobile device 500 then uses a communication channel 126, formed between the mobile device 500 and the remote server 300, to transmit the update initiation command 124 to the remote server 300. The communication channel 124 may utilize mobile data bandwidth or Wi-Fi. The update initiation command 124 triggers the remote server 300 to transmit the software package 10 containing a terminal software update to the mobile device 500 via the communication channel 126. In some examples, the remote server 300 may require log-in credentials 128 from the merchant prior to transmission of the software package 10. These log-in credentials 128 may be entered by the merchant via a user interface of the mobile device 500. The remote server 300 then verifies the log-in credentials 128 prior to transmitting the software package 10 to the mobile device 500

In this example, the mobile device 500 does not have to be in the same location as the payment terminal 100 to complete the download; indeed, the merchant may move the mobile device 500 to an area with improved connectivity to Wi-Fi or a mobile data network. Once the software package 10 has been downloaded to the mobile device 500, the mobile device 500 must then “push” the software package 10 to the payment terminal 100. The mobile device 500 may first provide a notification to the merchant to update the software of the payment terminal 100 using the software package 10 downloaded by the mobile device 500. The notification may include instructions for the merchant to facilitate the transfer of the software package 10 to the payment terminal 100. Next, in one example, a physical, wired connection 114 is formed between the payment terminal 100 and the mobile device 500. In one example, the wired connection 114 may be an On-the-Go (OTG) cable. In another example, a wireless connection 116 is formed between the payment terminal 100 and the mobile device 500. The wireless connection 116 may be formed using Bluetooth, Wi-Fi, or Near Field Communication (NFC) protocols, or any other appropriate wireless communication protocol. In a preferred example, this wired connection 114 or wireless connection 116 is different than the communication channel 126 used to convey the update initiation command 122 to the remote server 300 or the software package 10 to the mobile device. The software package 10 is then conveyed, via the wired or wireless connection 114, 116 to the payment terminal 100. Once received by the payment terminal 100, the software package 10 may be installed, updating one or more aspects of the software of the payment terminal 100.

In some examples, the wireless connection 116 may be facilitated by an “easy connect” feature of the payment terminal 100. In these examples, the payment terminal displays a second QR code to facilitate the formation of the wireless connection 116. The second QR code is captured by the mobile device 500. The mobile device 500 then extracts pairing information from the second QR code used to establish the wireless connection 116 between the mobile device 500 and the payment terminal 100, simplifying the process for the merchant.

Three important aspects of the solution illustrated by FIG. 6 are: (1) a mobile application operating on the mobile device 500 should use mobile data or Wi-Fi and download the software package 10 available for the payment terminal 100 to the mobile device 500; (2) once software package 10 is available on the mobile device 500, the mobile application will notify the merchant to update the software on the payment terminal 100; and (3) the mobile application shall provide instructions and steps to the merchant when software package 10 is ready to be installed.

This smart TMS solution will be platform independent (compatible with both iOS & Android) and allow multiple modes of operation. A first mode of operation is “Hotspot Direct.” In this first mode, the mobile device 500 acts as a wireless hotspot allowing the remote server 300 to connect directly to the payment terminal 100. In this mode, the mobile device 500 must remain in the same location as the payment terminal 100 to preserve connectivity. The mobile device 500 does not store the software package 10 conveyed to the payment terminal 100; it simply provides a network for connectivity.

A second mode of operation is “2 Stage Push,” and was described above with reference to FIG. 6. In this second mode, the mobile device 500 identifies software being run by the payment terminal 100, and then allows the merchant to download a software package 10 to the mobile device 500 at any time or location. Once the software package 10 is ready for installation, the merchant must return the mobile device to a location proximate to the payment terminal 100 to initiate installation, either via OTG cable, or via Wi-Fi, Bluetooth, or NFC protocol.

A third mode of operation is “Diagnostics & Statistics Relay.” In this third mode, the mobile device 500 interrogates the payment terminal 100 for any statistics or diagnostic data. This data is then relayed whenever the mobile device 500 connects to a remote server 300 (such as a payment host gateway).

This smart TMS solution would be capable of running on Android devices, such as the payment terminals 100 issued by the payment host, other vendor payment terminals, mobile devices 500, and tablet computers. The smart TMS solution would also be capable of running on iOS devices, such as MAC computers, tablet computers, and mobile phones. When the solution operates on a payment host device, increased security mechanisms are used to ensure the integrity of the information transferred, due to the inherent security built into the payment host payment terminals 100.

Currently, payment terminals 100 that do not have IP connectivity are updated via USB stick at great cost, as this requires sending an engineer to each site to conduct the upgrade. In other examples, some ECR solutions perform an ECR software push after the payment host delivers the software stack to the estate owner; the estate owner then manages the distribution. However, as these devices are not connected to payment host systems, they are unable to take the benefit of other payment host services such as diagnostics, statistics, and estate analysis. Software updates performed via low bandwidth connections can result in a merchant incurring out of contract fees at a considerable cost. Similarly, low bandwidth connections are also failing at a high frequency to perform these software updates; this increases the high-bandwidth frequency of the payment host headquarters, which in turn increases the data consumption.

Mobile two-stage push updates are not presently used by payment terminal vendors. Others have used mobile phones to update motor vehicle software, with different mechanisms for authentication, identification of the device to be updated, and communication update mechanisms. Currently all payment terminals connecting to payment host headquarters require a stable and fast IP connection, and all non-IP connected devices have lengthy and expensive upgrade processes. This solution will reduce cost and time when maintaining non-IP connected terminal software.

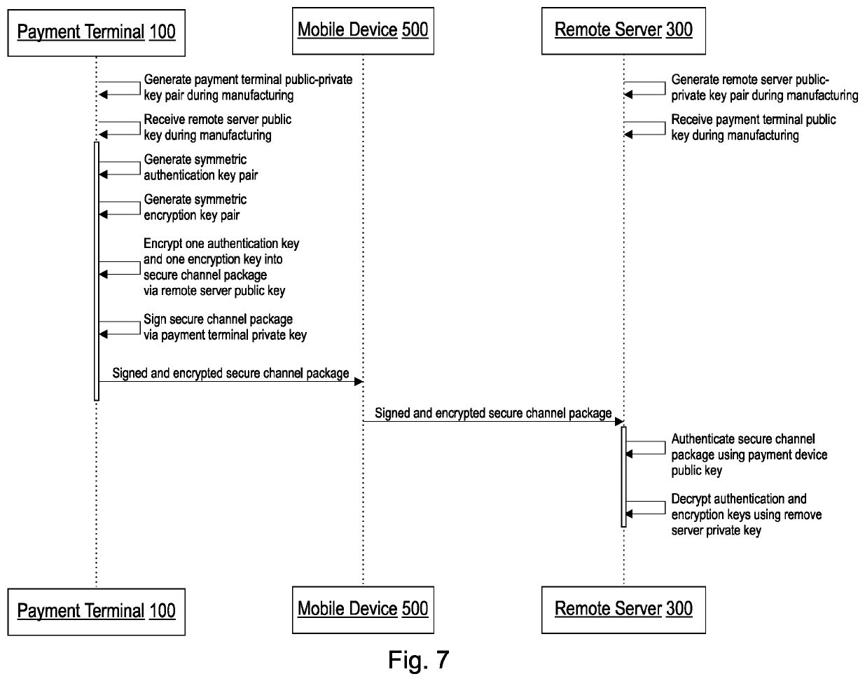

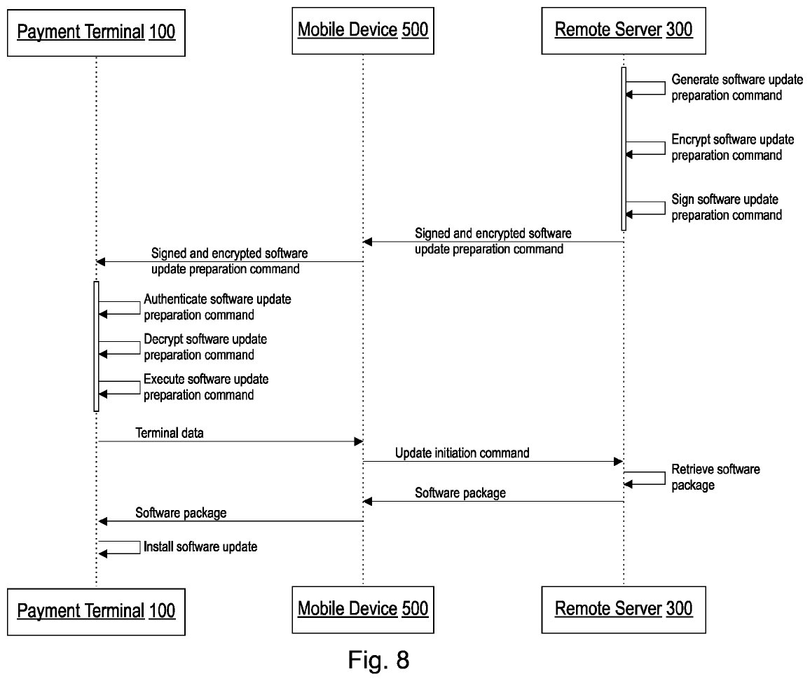

FIG. 7 is a flow diagram illustrating a method for sharing keys for authenticating and/or encrypting data sent between the payment terminal 100 and the remote server 300 using shared keys. In some examples, this data may include command data, control data, or configuration data. In the example of FIG. 8, a signed and encrypted software update preparation command 12 (see FIG. 9) is transmitted from the remote server 300 to the payment terminal 100 via the mobile device 500. As will be described below, once the payment terminal 100 receives, authenticates, decrypts, and executes the software update preparation command 12, the payment terminal 100 may then receive and install the software package 10.

As shown in FIG. 7, asymmetric public-private key pairs 18, 20 are generated for both the payment terminal 100 and the remote server 300. The public key 20a (scc FIG. 9) generated by the remote server 300 is provided to and stored on the payment terminal 100, while the public key 18a generated by the payment terminal 100 is provided to and stored on the remote server 300. In some examples, a certification authority may also issue trusted certificates corresponding to the public keys 18a, 20a stored on the payment terminal 100 and the remote server 300. These asymmetric key pairs 18, 20 are used to establish a secure channel between the payment terminal 100 and the remote server 300.

The payment terminal 100 then generates a symmetric authentication key pair 14a, 14b (see FIG. 9) and a symmetric encryption key pair 16a, 16b (see FIG. 9). These key pairs 14, 16 are used to encrypt and/or authenticate command-and-control data transmitted between the payment terminal 100 and the remote server 300. While asymmetric key pairs may be used instead, symmetric key pairs are preferred to reduce processing usage and time. The payment terminal 100 then encrypts one authentication key 14b and one encryption key 16b using the public key 20a from the remote server 300 to form a secure channel package. The secure channel package is then signed by the private key 18b of the payment terminal 100 generated during manufacturing. The secure channel package is then transmitted to the mobile device 500, which forwards the secure channel package to the remote server 300. As the file size of the secure channel package and subsequent command-and-control data is much smaller than a software update, the connectivity and bandwidth limitations described above are much less of a concern in forming a secure channel and sharing command-and-control data. The remote server 300 then authenticates the secure channel package using the public key 18a of the payment terminal 100 and decrypts the authentication and encryption keys 14b, 16b using the private key 20b of the remote server 300. Accordingly, both the public terminal 100 and the remote server 300 store corresponding symmetric keys 14a, 14b, 16a, 16b for authentication and encryption of command-and-control data, facilitating a bidirectional secure channel.

FIG. 8 illustrates how the shared symmetric keys 14, 16 may be used to convey command-and-control data over the secure channel between the remote server 300 and the payment terminal 100. The remote server 300 generates a software update preparation command 12 (see FIG. 9). The software update preparation command 12 may be configured to implement a download management plan on the payment terminal 100 or to provide a payload 24 (see FIG. 9) with files (such as media files) used by the software package 10 in updating the software of the payment terminal 100. The remote server 300 then encrypts the software update preparation command 12 using the shared symmetric encryption key 16b and signs the software update preparation command 12 using the shared symmetric authentication key 14b.

The remote server 300 then transmits the signed and encrypted software update preparation command 12 to the mobile device 500, which forwards the signed and encrypted software update preparation command 12 to the payment terminal 100. Encrypting the software update preparation command 12 prevents the mobile device 500 from reading the command 12, ensuring confidentiality. Signing the software update preparation command 12 prevents the mobile device from modifying the command 12, ensuring data integrity. The payment terminal 100 then uses its stored symmetric keys 14a, 16a to authenticate and decrypt the software update preparation command 12. The software update preparation command 12 is then executed by the payment terminal 100. If the software update preparation command 12 is not executed, the payment terminal 100 will not install the software package 10.

Next, the payment terminal 100 provides the mobile device 500 with terminal data 122 (see FIG. 9) either manually, via a QR code 112, or via other means. The mobile device 500 then generates an update initiation command 124 based on the terminal data 122 and transmits the update initiation command 124 to the remote server 300. The remote server 300 then retrieves the software package 10 to update the software of the payment terminal 100 based on the received update initiation command 124. The software package 10 is then transmitted to the mobile device 500, which forwards the software package 10 onto the payment terminal 100 using systems and methods described with reference to FIG. 6. Having previously executed the software update preparation command 12, the payment terminal 100 then installs the software package 10, successfully updating its software.

FIG. 9 schematically illustrates a payment terminal 100. The payment terminal 100 includes at least a display screen 118, a processor 150, a memory 175, and a transceiver 180. Memory 175 is configured to store at least a software package 10, a software update preparation command 12 (which may contain a payload 24), a symmetric authentication key 14a, a symmetric encryption key 16a, a payment terminal private key 18b, a remote server public key 20a, a remote server certificate 22, and terminal data 122. The corresponding symmetric authentication key 14b, symmetric encryption key 16b, payment terminal 18a, and remote server private key 20b are stored by the remote server 300 as described above with reference to FIGS. 7 and 8.

The processor 150 is configured to execute terminal software 1, which is updated by installation of the software package 10, following receipt of the software update preparation command 12. The processor 150 is also configured to execute a QR code generator 120, which generates a QR code 112 based on the terminal data 122. The display screen 118 is configured to display the QR code 112.

FIG. 10 is a flow chart of a method 900 for updating software of a payment terminal. The method 900 includes transmitting 902, via a mobile device over a communication channel, an update initiation command to a remote server. The update initiation command corresponds to terminal data of the payment terminal. The method 900 further includes receiving 904, via the mobile device over the communication channel, a software package transmitted by the remote server in response to receiving the update initiation command. The method 900 further includes transmitting 906, via the mobile device over a wired or wireless connection that is different than the communication channel, the software package to the payment terminal. The payment terminal is configured to install the software package upon receipt. According to an example, the software package may be received by the mobile device via Wi-Fi or mobile data. According to a further example, the software package may be transmitted by the mobile device to the payment terminal via Wi-Fi, Bluetooth, NFC, or an OTG cable.

In some examples, the method 900 may further include the optional step of scanning 908, via the mobile device, a QR code displayed by the payment terminal. The QR code includes the terminal data corresponding to the payment terminal. The method 900 may further include the optional step of generating 910, via the mobile device, the update initiation command based at least in part on the terminal data of the QR code.

In some examples, the method 900 may further include the optional step of transmitting 912, via the mobile device, log-in credentials to the remote server. The remote server is configured to verify the log-in credentials prior to transmitting the software package to the mobile device.

In some example, the method 900 may further include the optional step of transmitting 914, via the mobile device, a software update preparation command to the payment terminal. The software update preparation command may be encrypted and/or signed.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A system for facilitating a software update, comprising:
a payment terminal configured to display, via a screen, a QR code, wherein the QR code comprises terminal data corresponding to the payment terminal;
a mobile device configured to:
capture the QR code displayed on the payment terminal;
generate an update initiation command based at least in part on the terminal data of the QR code;
transmit the update initiation command; and
a remote server configured to:
receive the update initiation command transmitted by the mobile device; and
transmit a software package to the mobile device in response to receiving the update initiation command;
wherein the mobile device is further configured to transmit, via a wired or wireless connection, the software package to the payment terminal; and
wherein the payment terminal is further configured to install the software package.

2. The system of claim 1, wherein the wired or wireless connection utilizes Wi-Fi, Bluetooth, or Near Field Communication (NFC).

3. The system of claim 1, wherein the wired or wireless connection utilizes an On-the-Go (OTG) cable.

4. The system of claim 1, wherein the payment terminal is further configured to:
receive, via the wired or wireless connection, a software update preparation command, wherein the software update preparation command is encrypted and/or signed by a first key; and
decrypt and/or authenticate, via a second key corresponding to the first key, the software update preparation command prior to receiving the software package.

5. The system of claim 4, wherein the second key is stored in a memory of the payment terminal.

6. The system of claim 5, wherein the software update preparation command comprises a payload corresponding to the software package.

7. The system of claim 1, wherein the remote server is an app store.

8. A mobile device comprising a processor configured to:
transmit, via a communication channel, an update initiation command to a remote server, wherein the update initiation command corresponds to terminal data of a payment terminal;
receive, via the communication channel, a software package transmitted by the remote server, wherein the software package corresponds to the update initiation command; and
transmit, via a wired or wireless connection, the software package to the payment terminal, wherein the wired or wireless connection is different than the communication channel.

9. The mobile device of claim 8, wherein the processor is further configured to:
capture a QR code displayed on the payment terminal, wherein the QR code comprises the terminal data of the payment terminal; and
generate the update initiation command based at least in part on the terminal data of the QR code.

10. The mobile device of claim 8, wherein the wired or wireless connection utilizes Wi-Fi, Bluetooth, or Near Field Communication (NFC).

11. The mobile device of claim 8, wherein the wired or wireless connection utilizes an On-the-Go (OTG) cable.

12. The mobile device of claim 8, wherein the processor is further configured to transmit, prior to transmission of the software package, a software update preparation command

13. The mobile device of claim 12, wherein the software update preparation command is encrypted and/or signed.

14. A method for updating software of a payment terminal, comprising:
transmitting, via a mobile device over a communication channel, an update initiation command to a remote server, wherein the update initiation command corresponds to terminal data of the payment terminal;
receiving, via the mobile device over the communication channel, a software package transmitted by the remote server in response to receiving the update initiation command;
transmitting, via the mobile device over a wired or wireless connection that is different than the communication channel, the software package to the payment terminal, wherein the payment terminal is configured to install the software package upon receipt.

15. The method of claim 14, further comprising:
scanning, via the mobile device, a QR code displayed by the payment terminal, wherein the QR code comprises the terminal data corresponding to the payment terminal; and
generating, via the mobile device, the update initiation command based at least in part on the terminal data of the QR code.

16. The method of claim 14, wherein the software package is received via Wi-Fi or mobile data.

17. The method of claim 14, wherein the software package is transmitted by the mobile device to the payment terminal via Wi-Fi, Bluetooth, Near Field Communication (NFC), or an On-the-Go (OTG) cable.

18. The method of claim 14, further comprising transmitting, via the mobile device, log-in credentials to the remote server, wherein the remote server is configured to verify the log-in credentials prior to transmitting the software package to the mobile device.

19. The method of claim 14, further comprising transmitting, via the mobile device, a software update preparation command to the payment terminal.

20. The method of claim 19, wherein the software update preparation command is encrypted and/or signed.
